(19) United States
(12) Patent Application Publication
(10) Pub. No.: US 2018/0366811 A1
(43) Pub. Date: Dec. 20, 2018

(54) HOUSING, METHOD FOR PRODUCING THE SAME AND MOBILE TERMINAL

(71) Applicant: GUANGDONG OPPO MOBILE TELECOMMUNICATIONS CORP., LTD., Dongguan (CN)

(72) Inventors: Zhiyong HUANG, Dongguan (CN); Guangming YANG, Dongguan (CN)

(73) Assignee: GUANGDONG OPPO MOBILE TELECOMMUNICATIONS CORP., LT D., Dongguan (CN)

(21) Appl. No.: 15/953,419

(22) Filed: Apr. 14, 2018

(30) Foreign Application Priority Data
Jun. 16, 2017 (CN) 201710456692.4
Jun. 16, 2017 (CN) 201710457349.1
Jun. 16, 2017 (CN) 201720708947.7

(51) Int. Cl. H01Q 1/24; H01Q 1/22

(52) U.S. Cl. CPC H01Q 1/243; H01Q 1/2266

(57) ABSTRACT

A housing, a method for producing the same and a mobile terminal having the same are provided. The housing includes a metallic substrate, a groove, at least one hole and an antenna. The groove is defined in the substrate. The at least one hole passes through the substrate and communicates with the groove. The antenna piece is disposed in the groove and the at least one hole, and insulated from the substrate.

### CROSS-REFERENCE TO RELATED APPLICATION

This application claims priority to and benefits of Chinese Patent Application Serial No. 201720708947.7, filed with the State Intellectual Property Office of P. R. China on Jun. 16, 2017, Chinese Patent Application Serial No. 201710457349.1, filed with the State Intellectual Property Office of P. R. China on Jun. 16, 2017 and Chinese Patent Application Serial No. 201710456692.4, filed with the State Intellectual Property Office of P. R. China on Jun. 16, 2017, the entire contents of which are incorporated herein by reference.

### FIELD

The present disclosure relates to the field of mobile terminals, and more particularly to a housing, a method for producing the same and a mobile terminal comprising the same.

### BACKGROUND

With the rapid development of electronic products such as mobile phones, tablet computers and laptop computers, various kinds of electronic products are updated quickly, and there are higher requirements on various aspects of the electronic products, especially mobile terminals, such as mobile phones. In addition to the use functions, there are higher requirements on the appearance of electronic products. Metallic housings are widely used in various electronic devices due to their beautiful appearances. However, a housing made of a complete layer of metal will result in a shielding effect and thus will interfere with mobile phone communication. Therefore, a non-metallic antenna piece is needed in the metallic housing.

However, the current metal-based housings, methods for producing the same and mobile terminals having the same still need to be improved.

### SUMMARY

According to embodiments of a first aspect of the present disclosure, there is provided a housing. The housing includes a metallic substrate, a groove, at least one hole and an antenna piece. The groove is defined in the substrate. The at least one hole passes through the substrate and communicates with the groove. The antenna piece is disposed in the groove and the at least one hole, and insulated from the substrate.

According to embodiments of a second aspect of the present disclosure, there is provided a method for producing the housing as described above. The method includes: providing a substrate; defining a groove and at least one hole in the substrate; and providing an antenna piece in the groove and the at least one hole, in which the at least one hole passes through the substrate, is located at a bottom of the groove and communicates with the groove, and the antenna piece is insulated from the substrate.

According to embodiments of a third aspect of the present disclosure, there is provided a mobile terminal including a housing. The housing includes a metallic substrate, a groove, at least one hole, an insulation layer and an antenna piece. The groove is defined in the substrate. The at least one hole passes through the substrate and is at a bottom of the groove. The insulation layer covers an inner surface of the groove and a circumferential wall of the at least one hole. The antenna piece is disposed in the groove and the at least one hole, and insulated from the substrate.

### BRIEF DESCRIPTION OF THE DRAWINGS

FIG. 1 is a cross-sectional view of a housing according to an embodiment of the present disclosure.

FIG. 2 is a cross-sectional view of a housing according to another embodiment of the present disclosure.

FIG. 3 is a schematic view illustrating partial structure of a housing according to yet another embodiment of the present disclosure.

FIG. 4 is a schematic view illustrating partial structure of a housing according to a further embodiment of the present disclosure.

FIG. 5 is a flow chart illustrating a method for producing a housing according to an embodiment of the present disclosure.

FIG. 6 illustrates cross-sectional views showing successive stages in a method for producing a housing according to an embodiment of the present disclosure.

FIG. 7 illustrates cross-sectional views showing successive stages in a method for producing a housing according to another embodiment of the present disclosure.

FIG. 8 illustrates cross-sectional views showing successive stages in a method for producing a housing according to yet another embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. Embodiments without specifying detailed technologies or conditions are carried out following the technologies or conditions described in literatures in the related art or product specifications. Reagents or instruments without indicating manufacturers are conventional products commercially available.

The present disclosure is based on the following findings of the inventors.

At present, an antenna slot is generally needed in the current whole metallic housing of a mobile terminal like a mobile phone, which results in non-uniform appearance and poor strength. Inventors of the present disclosure have founded through intensive study and a large number of experiments that, the main reason is that, currently, an antenna piece is commonly disposed inside a housing of a mobile phone, a “three-section structure” is adopted when the housing is produced from a metal material, and the antenna slot which allows the signal to pass through the housing is formed at a location of the antenna piece. That is, one or more slots penetrating through the metallic housing are formed in the housing of the mobile phone and are filled with an insulating material (such as plastics and the like), and a metallic part above the slot and a metallic part below the slot can be spaced apart by the insulating material, resulting in a clearance area. In such a case, a slot needs to be processed and filled with such as plastics. However, this process will not only affect the appearance integrity of the housing, but also increase the processing time. Furthermore, the clearance area will result in a decline of the overall mechanical property of the metallic housing. In addition, if the metallic housing can be multi-functionalized, the internal volume of the mobile terminal will be further reduced and the mobile terminal will be thinner.

Embodiments of the present disclosure seek to solve at least one of the problems existing in the related art to at least some extent. For this, an object of the present disclosure is to provide a housing with an antenna piece without a penetrated slot, so as to achieve the communication of a mobile terminal.

The disclosure relates to a housing. The housing may include a metallic substrate; a groove defined in the substrate; at least one hole passing through the substrate and communicating with the groove; and an antenna piece disposed in the groove and the at least one hole, and insulated from the substrate. Therefore, the antenna piece may be disposed outside the housing and connected with an interior component of a mobile terminal through the hole so as to achieve the function of the antenna piece. In addition, there are only a small number of penetrating holes defined in the housing, and the overall mechanical property of the metallic housing can be guaranteed. In general, the housing according to embodiments of the present disclosure has a simple processing technology, a uniform appearance, a high mechanical strength, and can save inner space of the mobile terminal with such a housing.

In an embodiment of the present disclosure, the housing further includes an insulation layer covering an inner surface of the groove and an inner surface of the at least one hole, and insulating the antenna piece from the substrate.

In an embodiment of the present disclosure, a depth of the groove is not greater than 50% of a thickness of the substrate.

In an embodiment of the present disclosure, the depth of the groove is in a range of 0.05 to 0.2 mm.

In an embodiment of the present disclosure, the housing further includes a connector disposed at a bottom of the hole and configured to connect with the antenna piece.

In an embodiment of the present disclosure, the connector is a copper foil or a metal block.

In an embodiment of the present disclosure, the antenna piece includes at least one selected from a metal, a conducting polymer, or a laser direct structuring LDS material.

In an embodiment of the present disclosure, the housing further includes a protective layer covering the antenna piece and a surface of the substrate where the groove is defined.

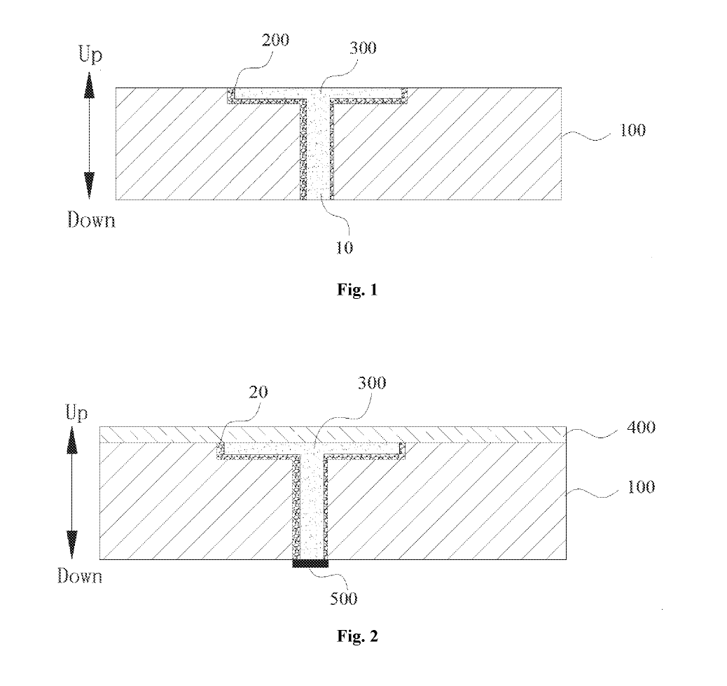

In an embodiment of a first aspect of the present disclosure, a housing is provided. As shown in FIG. 1, the housing includes a substrate 100, a groove 200, at least one hole 10 and an antenna piece 300. The at least one hole 10 passes through the substrate 100 and communicates with the groove 200. The antenna piece 300 is disposed in the groove 200 and the at least one hole 10, and insulated from the substrate 300, and is configured to radiate an antenna signal. Therefore, the housing is allowed to further possess a function of the antenna, thereby saving inner space intended to arrange the antenna piece of a mobile terminal. In general, the housing according to embodiments of the present disclosure has a simple processing technology, a uniform appearance, a high mechanical strength, and can save inner space of the mobile terminal.

In an embodiment of the present disclosure, the substrate 100 includes a metal material. In an embodiment of the present disclosure, the substrate 100 may be made of the metal material. It should be illustrated that, the material used in the substrate 100 is not specifically limited in the present disclosure, and can be any material known in the related art which can be used in a housing of a mobile terminal, such as a mobile phone, including but not limited to aluminum alloy, stainless steel and the like. The substrate 100 is not limited to a specific shape, as long as it can be assembled with other parts of the mobile terminal (such as mobile phone), which can be flexibly determined by those skilled in the art according to actual requirements. For example, the substrate 100 may be produced by processing the metal material with technologies including but not limited to computer numerical control (CNC) technology, forging technology or stamping technology. The housing including the substrate 100 may be a rear housing or a housing having a side frame of a mobile terminal, such as a mobile phone. The housing may be a planar housing, a 2D rear housing with a certain radian at the edge, or a 3D housing overall with a certain radian.

It should be illustrated that, in embodiments of the present disclosure, the number and shape of the groove 200 are not specifically limited, and the groove 200 is configured to accommodate the antenna piece 300, so as to limit the antenna piece 300 in the substrate 100. Therefore, the shape of the groove 200 and its location in the substrate 100 depends on the number and location of the antenna piece 300. In an embodiment of the present disclosure, a depth of the groove 200 is smaller than a thickness of the substrate 100, that is, the groove 200 does not penetrate through the substrate 100. In an embodiment of the present disclosure, the depth of the groove 200 (a distance from a top of the groove 200 to a bottom of the groove 200 in an up-down direction as shown in FIG. 1) is not greater than 50% of the thickness of the substrate 100 (a distance from the top of the substrate 100 to a bottom of the substrate 100 in the up-down direction). Therefore, formation of penetrating structures (such as penetrating slots) with a large area in the substrate 100 can be avoided, thereby guaranteeing an overall mechanical strength of the substrate 100. In an embodiment of the present disclosure, the depth of the groove 200 may be in a range of 0.05 to 0.2 mm, for example, the depth of the groove 200 may be 0.1 mm.

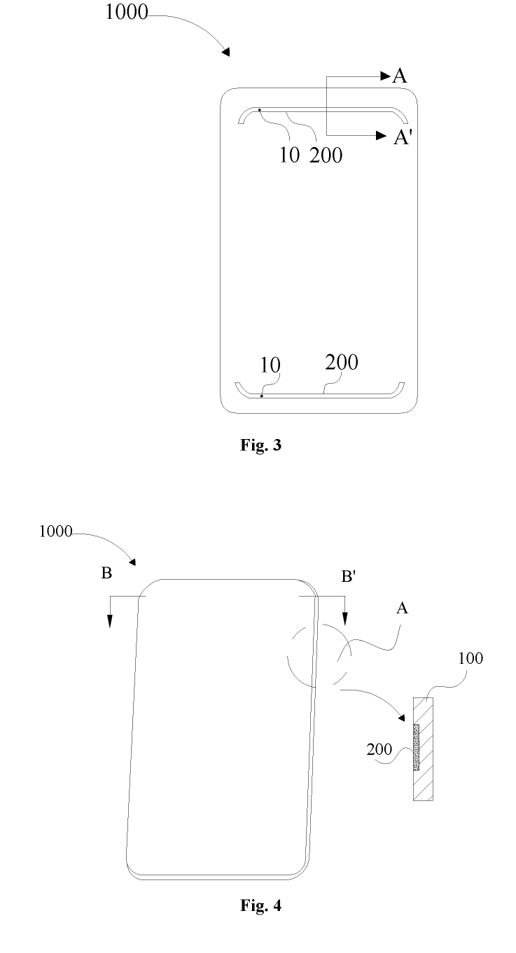

In an embodiment of the present disclosure, as shown in FIG. 3, the housing 1000 may include a first groove 200 at an upper side thereof and a second groove 200 at a lower side thereof. The antenna piece 300 (not shown) is disposed in each of the first and second grooves 200. The hole 10 penetrating through the substrate 100 is formed at a location where the antenna piece 300 needs to be connected with hardware components of the mobile terminal, such as mobile phone. FIG. 1 is a cross-sectional view of the housing shown in FIG. 3 in an A-A′ detection. It can be seen from FIG. 3 that, by adopting the hole 10 with a small area in the housing 1000 according to embodiments of the present disclosure, the function of the antenna piece 300 can be achieved, thereby avoiding the penetrating slot with a large area. Therefore, not only can the producing process be simplified, but also the overall mechanical property of the housing 1000 can be improved greatly.

In some embodiments of the present disclosure, as shown in FIG. 4, the housing 1000 may also be a 2D or 3D housing with a certain radian at side edges. The groove 200 and the antenna piece 300 can be disposed in a side wall of the housing 1000, i.e., region A, whose enlarged cross-section view in a B-B′ direction is also shown in FIG. 4. Therefore, while realizing the antenna piece communication, the housing having an entire metallic surface can be achieved.

In an embodiment of the present disclosure, the antenna piece 300 is disposed in the groove 200 and the at least one hole 10, and is insulated from the substrate 100. In an embodiment, an upper surface of the antenna piece 300 may be flush with an upper surface of the substrate 100, which is beneficial to the subsequent surface treatment to form a smooth and uniform housing. Moreover, interior space of electronic devices will be saved by integrating the antenna piece 300 to the housing according to embodiments of the present disclosure. Furthermore, the antenna piece 300 is insulated from the substrate 100, and thus the signal transmission function of the antenna piece can be realized. In an embodiment of the present disclosure, the antenna piece 300 may include at least one selected from a metal, a conducting polymer, or a laser direct structuring (LDS) material. In an embodiment of the present disclosure, the antenna piece 300 may be made of at least one selected from a metal, a conducting polymer, or a LDS material. As those materials have conductivity, the function of the antenna piece can be realized. The antenna piece 300 can be easily disposed in the groove 200 and the at least one hole 10 by filling or depositing the above materials in the groove 200 and the at least one hole 10. For example, in an embodiment, the LDS material, a modified plastic containing an organometallic complex which can release metal particles if activated by laser irradiation, can be filled in the groove 200 and the at least one hole 10. Therefore, the antenna piece 300 with a conductive function can be easily formed in the groove.

In an embodiment of the present disclosure, as shown in FIG. 2, the insulation between the antenna piece 300 and the substrate 100 may be achieved by providing an insulation layer 20 in the groove 200 and the at least one hole 10. Specifically, the insulation layer 20 covers an inner surface of the groove 200 and an inner surface of the at least one hole 10. That is, the insulation layer 20 covers the inner surface of the groove 200 and a circumferential wall of the hole 10, and the hole 10 is still a through-hole. Therefore, the insulation between the antenna piece 300 and the substrate 100 can be achieved, while keeping the hole 10 for connecting the antenna piece 300 and the interior component (such as an antenna feeding piece) of the electronic device. It should be illustrated that, in the present disclosure, the insulation layer 20 is not limited to a specific material, as long as the insulation can be achieved. For example, in an embodiment, the insulation layer 20 can be provided by shading a portion of the hole 10 and then providing an insulation adhesive onto the inner surface of the groove and the inner surface of the hole 10 by a spraying, printing or dispensing process. Alternatively, the insulation adhesive can be directly coated in the groove 200 and the hole 10, and then a portion of the insulation adhesive in the hole 10 is removed, in this way, not only can the hole 10 be guaranteed to penetrate through the substrate 100, but also accuracy control of the spraying, printing or dispensing process for providing the insulation layer can be reduced. It will be appreciated by those skilled in the art that, as the groove 200 needs to accommodate the antenna piece 300 after the insulation layer 20 is provided, a thickness of the insulation layer 20 needs to be smaller than the depth of the groove 200 so as to leave accommodating space for the antenna piece 300.

In an embodiment of the present disclosure, a connection manner of the antenna piece 300 and the hardware component is not specifically limited, as long as the antenna piece 300 and the hardware component can be connected through the hole 10. For example, in an embodiment, an inner wall of the hole may be deposited with a small piece of metal or provided with a copper foil so as to achieve the electrical connection. Alternatively, with reference to FIG. 2, a connector 500 is disposed at a bottom of the hole 10 and configured to connect with the antenna piece 300. The connector 500 may be a small metal block having conductivity. Therefore, the connection of the antenna piece 300 and the hardware component, such as the antenna feeding piece disposed in the mobile terminal, can be achieved conveniently.

In an embodiment of the present disclosure, in order to further improve the appearance of the housing 1000, the housing 1000 may further includes a protective layer 400. The protective layer 400 covers the antenna piece 300 and a surface of the substrate 100 where the groove is defined, and may be provided by a spraying or high pressure coating process. With the protective layer 400, the antenna piece 300 can be protected on the one hand, and the appearance of the housing can be improved on the other hand.

The disclosure further relates to a method for producing a housing. The method can include the following. A substrate is provided. A groove and at least one hole are defined in the substrate. An antenna piece is provided in the groove and the at least one hole, in which the at least one hole passes through the substrate, is located at a bottom of the groove and communicates with the groove, and the antenna piece is insulated from the substrate.

In an embodiment of the present disclosure, defining a groove and at least one hole in the substrate includes defining the groove in the substrate; and defining the hole through the substrate at the bottom of the groove.

In an embodiment of the present disclosure, defining a groove and at least one hole in the substrate includes defining in the substrate a hole through the substrate; and defining a groove based on the hole, and the hole is at the bottom of the groove.

In an embodiment of the present disclosure, providing an antenna piece in the groove and the at least one hole includes providing an insulation layer on an inner surface of the groove and an inner surface of the at least one hole; and providing the antenna piece in the groove and the at least one hole provided with the insulation layer, and the antenna piece includes at least one selected from a metal, a conducting polymer, or LDS material.

In an embodiment of the present disclosure, providing the antenna piece in the groove and the at least one hole provided with the insulation layer includes filling the LDS material in the groove and the at least one hole; and performing a metallization process to the LDS material to form the antenna piece.

In an embodiment of the present disclosure, a thickness of the insulation layer is controlled to be smaller than a depth of the groove.

In an embodiment of the present disclosure, a depth of the groove is not greater than 50% of a thickness of the substrate.

In an embodiment of the present disclosure, after providing an antenna piece in the groove and the at least one hole, the method further includes at least one of the following operations: providing at a bottom of the hole a connector configured to connect with the antenna piece; and providing a protective layer covering the antenna piece and a surface of the substrate where the groove is defined.

In an embodiment of the present disclosure, the substrate is produced by a computer numerical control technology, a forging technology or a stamping technology.

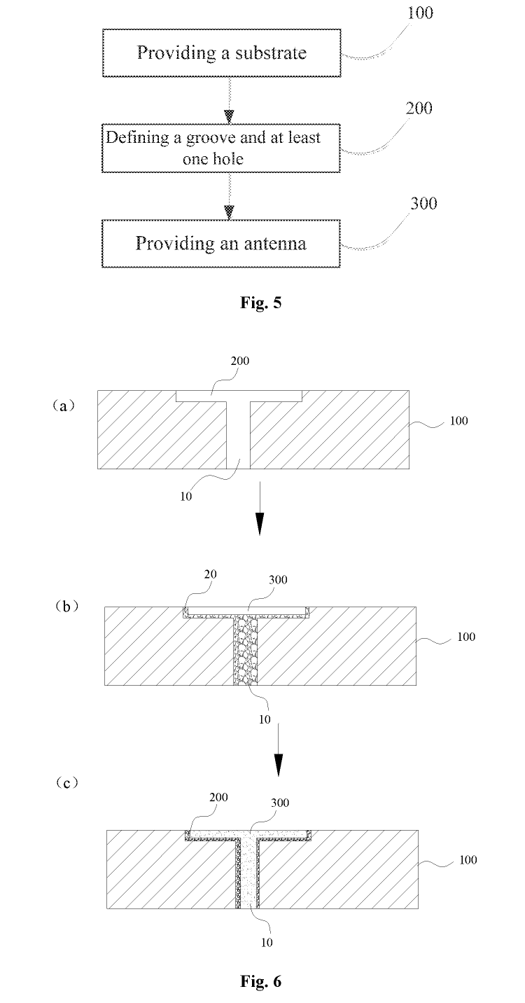

In an embodiment, the housing produced with the method may be a housing as described hereinbefore. The method includes operations at blocks illustrated in FIG. 5.

At block 100, a substrate is provided.

According to an embodiment of the present disclosure, at this block, a metal material can be processed into the substrate with a certain shape by technologies including but not limited to stamping technology, forging technology or CNC technology. With respect to the material and structure of the substrate, detailed descriptions have been made hereinbefore, and will not be elaborated here.

At block 200, a groove and at least one hole are defined.

According to an embodiment of the present disclosure, at this block, the groove and at least one hole is defined in the above substrate, and the at least one hole passes through the substrate, is located at a bottom of the groove and communicates with the groove. It should be illustrated that, the method for processing the groove and the hole is not specifically limited in the present disclosure, and those skilled in the art can choose a familiar metal processing method. Therefore, the groove and the hole can provide an accommodating space for an antenna piece provided in the subsequent operations, and the antenna piece disposed in the groove and the hole may connect through the hole with a hardware component, such as an antenna feeding piece disposed in the mobile terminal, so as to radiate an antenna signal.

For example, in an embodiment of the present disclosure, the groove and at least one hole are defined by defining the groove in the substrate with a depth of the groove smaller than a thickness of the substrate, and defining the hole through the substrate at the bottom of the groove. The specific location of the hole can be determined according to a location of a hardware component (such as an antenna feeding piece) of a mobile terminal with the housing of the present disclosure.

Alternatively, in another embodiment of the present disclosure, the groove and at least one hole are defined by defining in the substrate a hole through the substrate; and defining a groove by processing the substrate such as with an etching method in two opposite directions according to the location of the hole, and the hole is at the bottom of the groove.

It should be illustrated that, in embodiments of the present disclosure, the number and shape of the groove are not specifically limited, and the groove may have the same structure as the groove described in the above embodiment, which will not be elaborated here.

At block 300, an antenna piece is provided.

According to an embodiment of the present disclosure, at this block, an antenna piece is provided in the groove and the hole, so as to radiate an antenna signal, and the antenna piece is insulated from the substrate. The antenna piece provided in this block may be the same as the antenna piece of the housing described hereinbefore, and will not be elaborated here.

In an embodiment of the present disclosure, the antenna piece may be formed by filling an LDS material in the groove and the hole and activating the LDS material by laser irradiation or chemical plating process and the like to release metal particles therein.

When the housing is assembled to a mobile terminal, such as a mobile phone, the function of the antenna piece can be achieved by connecting the antenna piece provided in this block with the hardware component (such as the antenna feeding piece) through the hole as described above.

It will be appreciated that, as the substrate includes a metal material, in order to realize the function of the antenna piece, the antenna piece needs to be insulated from the substrate. In an embodiment of the present disclosure, the insulation of the antenna piece from the substrate may be achieved by providing an insulation layer in the groove and the hole. Specifically, the insulation layer covers an inner surface of the groove and an inner surface of the hole, i.e., covers the inner surface of the groove and a circumferential wall of the at least one hole. That is, all the vertical side walls and bottom surfaces of the groove and the circumferential wall of the hole are covered by the insulation layer, and the hole still is a through-hole. In this way, the insulation of the antenna piece from the substrate may be achieved, and the hole can be kept to be a through-hole, so as to connect the antenna piece with the interior component (such as an antenna feeding piece) of the electronic device. In the present disclosure, the process and material of the insulation layer is not specifically limited, as long as the insulation can be achieved. For example, in an embodiment, the insulation layer can be provided by shading a portion of the hole and then providing an insulation adhesive onto the inner surface of the groove and the inner surface of the hole 10 by a spraying, printing or dispensing process. Alternatively, the insulation adhesive can be directly coated in the groove and the hole, and then a portion of the insulation adhesive in the hole is removed, in this way, not only can the hole be guaranteed to penetrate through the substrate, but also accuracy control of the spraying, printing or dispensing process for providing the insulation layer can be reduced. It will be appreciated by those skilled in the art that, as the groove needs to accommodate the antenna piece after the insulation layer is provided, a thickness of the insulation layer needs to be smaller than the depth of the groove so as to leave accommodating space for the antenna piece.

According to embodiments of the present disclosure, in order to further improve the performance of the housing produced according to the method of the present disclosure, the method may further include at least one of the following operations.

A connector is provided.

In order to connect the antenna piece with the hardware component, such as an antenna feeding piece, in an embodiment of the present disclosure, the connector may be provided at the hole after the antenna piece is provided in the groove and the hole. Specifically, a small piece of metal may be deposited on an inner wall of the hole or a copper foil may be provided on the inner wall of the hole, so as to form the connector. Alternatively, a small metal block having conductivity may be disposed at a bottom of the hole to form the connector. In this way, the connection of the antenna piece and the hardware component, such as the antenna feeding piece disposed in the mobile terminal, can be achieved conveniently.

A protective layer is provided.

In embodiments of the present disclosure, the method may further include providing the protective layer. In a specific embodiment, the protective layer covers the antenna piece and a surface of the substrate where the groove is defined, and may be provided by a spraying or high pressure coating process. With the protective layer, the antenna piece can be protected on the one hand, and the appearance of the housing can be improved on the other hand. Therefore, the performance of the housing produced with the method of the present disclosure can be further improved. In an embodiment, the housing produced with the method of the present disclosure may have the structure as shown in FIG. 2, the substrate 100 defines the groove 200 and at least one hole 10 at the bottom of the groove 200 and through the substrate 100, the antenna piece 300 is disposed in the groove 200 and at least one hole 10, and insulated from the substrate 100, the connector 500 is disposed at the bottom of the hole 10, and the protective layer 400 is provided on the upper surface of the substrate 100 (i.e., the surface of the substrate where the groove is defined) to cover the antenna piece and the upper surface of the substrate.

Therefore, with the method according to embodiments of the present disclosure, the housing can be produced easily, and the produced housing has a uniform appearance, a high mechanical strength, and can save inner space of the mobile terminal.

In specific embodiments of the present disclosure, the method may include the following operations.

Referring to FIG. 6 (a)-(c), the groove 200 is defined in the substrate 100. The depth of the groove 200 is not greater than 50% of the height (i.e., thickness) of the substrate 100. For example, the depth of the groove 200 may be 0.1 mm. Then, the hole 10 through the substrate 100 is formed at the bottom of the groove 200. That is, the groove 200 may be formed first, and then the hole 10 through the substrate 100 is formed at the bottom of the groove 200. Subsequently, an insulating material (refer to 20 shown in FIG. 6) is deposited in the groove 200 and the hole 10, and a portion of the insulating material in the hole 10 is removed, so as to from an insulation layer. Afterwards, the LDS material is filled in the groove 200 and the hole 10 provided with the insulation layer and activated by laser irradiation to release metal particles, so as to form the antenna piece 300.

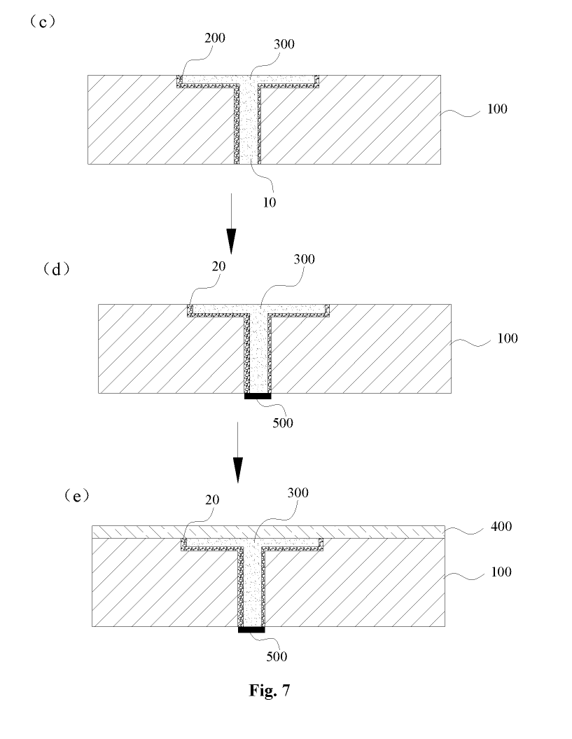

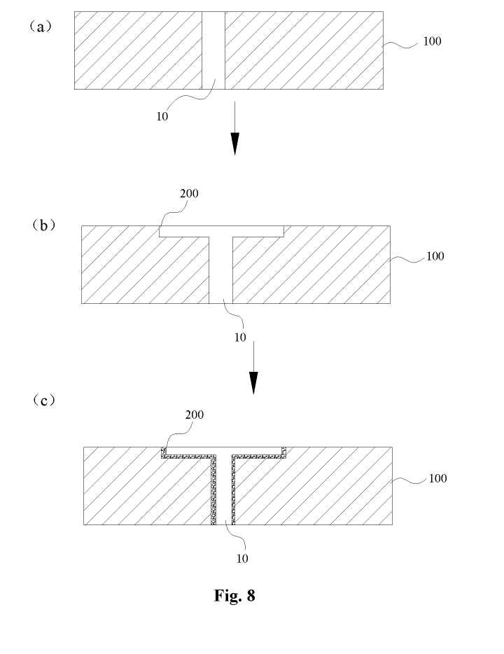

Referring to FIG. 7 (c)-(e), the connector 500 is provided at a bottom of the hole, a first end of the connector 500 is in contact with the antenna piece 300, and the connector 500 may be a metal block. Therefore, when the housing is assembled to a mobile terminal, such as a mobile phone, a second end of the connector 500 is in contact with a reserved terminal, so as to connect the antenna piece 300 with the hardware component. Finally, a protective layer 400 may be provided on a surface of the substrate 100 where the groove is defined, i.e., an outer surface of the substrate 100, by spraying or high-pressure coating process. Therefore, with the protective layer 400, the antenna piece 300 can be protected so as to prolong its service life on the one hand, and the appearance of the housing can be further improved on the other hand.

Alternatively, referring to FIG. 8 (a)-(c), in another specific embodiment of the present disclosure, the hole 10 through the substrate 100 may be formed first, then, the groove 200 is formed in the top of the substrate 100 according to the location of the hole 10. It should be illustrated that, “the top of the substrate” specifically refers to the upper surface of the substrate, i.e., a side of the substrate facing external environment in practical application of the housing.

In an embodiment of a third aspect of the present disclosure, a mobile terminal is provided, including the housing as described hereinbefore. Therefore, the mobile terminal has all the features and advantages of the housing described hereinbefore, which will not be elaborated here. In general, the mobile terminal according to embodiments of the present disclosure has a simple housing processing technology, a uniform appearance, a high mechanical strength, and can have a compact inner space.

In an embodiment of the present disclosure, a mobile terminal is provided, including a housing, and the housing includes: a metallic substrate; a groove disposed in the substrate; at least one hole passing through the substrate and at a bottom of the groove; an insulation layer covering an inner surface of the groove and a circumferential wall of the at least one hole; and an antenna piece disposed in the groove and the at least one hole, and insulated from the substrate.

It should be illustrated that, the mobile terminal is not limited to a specific type. In embodiments of the present disclosure, the mobile terminal may be a mobile phone, a tablet computer or a laptop computer and the like. In the mobile terminal, the housing is not particular limited to a specific shape. For example, in a mobile phone, the housing may only include a backplane, and the backplane may have a certain radian (such as a 3D rear housing) or have no radian (such as a flat plate), or the housing may also be an integrated housing, including both the rear housing part and side frames of the mobile phone.

In the specification, it is to be understood that terms such as “central,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” should be construed to refer to the orientation as then described or as shown in the drawings under discussion. These relative terms are for convenience of description and do not indicate or imply that the device or element referred to must have a particular orientation or require that the present disclosure be constructed or operated in a particular orientation.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine the different embodiments or examples described in this specification, or combine the features of different embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A housing, comprising:
a metallic substrate;
a groove defined in the substrate;
at least one hole passing through the substrate and communicating with the groove; and
an antenna piece disposed in the groove and the at least one hole, and insulated from the substrate.

2. The housing according to claim 1, further comprising an insulation layer covering an inner surface of the groove and an inner surface of the at least one hole, and insulating the antenna piece from the substrate.

3. The housing according to claim 1, wherein a depth of the groove is not greater than 50% of a thickness of the substrate.

4. The housing according to claim 3, wherein the depth of the groove is in a range of 0.05 to 0.2 mm.

5. The housing according to claim 1, further comprising a connector disposed at a bottom of the hole and configured to connect with the antenna piece.

6. The housing according to claim 5, wherein the connector is a copper foil or a metal block.

7. The housing according to claim 1, wherein the antenna piece comprises at least one selected from a metal, a conducting polymer, or a laser direct structuring LDS material.

8. The housing according to claim 1, further comprising a protective layer covering the antenna piece and a surface of the substrate where the groove is defined.

9. A method for producing a housing, comprising:
providing a substrate;
defining a groove and at least one hole in the substrate; and
providing an antenna piece in the groove and the at least one hole,
wherein the at least one hole passes through the substrate, is located at a bottom of the groove and communicates with the groove, and the antenna piece is insulated from the substrate.

10. The method according to claim 9, wherein defining a groove and at least one hole in the substrate comprises:
defining the groove in the substrate; and
defining the hole through the substrate at the bottom of the groove.

11. The method according to claim 9, wherein defining a groove and at least one hole in the substrate comprises:
defining in the substrate a hole through the substrate; and
defining a groove based on the hole,
wherein the hole is at the bottom of the groove.

12. The method according to claim 9, wherein providing an antenna piece in the groove and the at least one hole comprises:
providing an insulation layer on an inner surface of the groove and an inner surface of the at least one hole; and
providing the antenna piece in the groove and the at least one hole provided with the insulation layer,
wherein the antenna piece comprises at least one selected from a metal, a conducting polymer, or LDS material.

13. The method according to claim 12, wherein providing the antenna piece in the groove and the at least one hole provided with the insulation layer comprises:
filling the LDS material in the groove and the at least one hole; and
performing a metallization process to the LDS material to form the antenna piece.

14. The method according to claim 12, wherein a thickness of the insulation layer is controlled to be smaller than a depth of the groove.

15. The method according to claim 9, wherein a depth of the groove is not greater than 50% of a thickness of the substrate.

16. The method according to claim 9, wherein after providing an antenna piece in the groove and the at least one hole, the method further comprises at least one of the following operations:
providing at a bottom of the hole a connector configured to connect with the antenna piece; and
providing a protective layer covering the antenna piece and a surface of the substrate where the groove is defined.

17. The method according to claim 9, wherein the substrate is produced by a computer numerical control technology, a forging technology or a stamping technology.

18. A mobile terminal, comprising a housing, wherein the housing comprises:
a metallic substrate;
a groove defined in the substrate;
at least one hole passing through the substrate and at a bottom of the groove;
an insulation layer covering an inner surface of the groove and a circumferential wall of the at least one hole; and
an antenna piece disposed in the groove and the at least one hole, and insulated from the substrate.

19. The mobile terminal according to claim 18, wherein the antenna piece comprises at least one selected from a metal, a conducting polymer, or an LDS material.

20. The mobile terminal according to claim 18, wherein the mobile terminal is a mobile phone, a tablet computer or a laptop computer.
